(19) United States
(12) Patent Application Publication
(10) Pub. No.: US 2007/0001951 A1
(43) Pub. Date: Jan. 4, 2007

(54) Field-sequential color architecture for low-power liquid crystal displays

(75) Inventors: Achintya K. Bhowmik, Milpitas, CA (US); David L. Williams, San Jose, CA (US); James Kardach, Saratoga, CA (US); Shida Tan, Milpitas, CA (US); Ralph M. Mesmer, Banks, OR (US)

Correspondence Address: INTEL CORPORATION, P.O. BOX 5326, SANTA CLARA, CA, 95056-5326, US

(73) Assignee: Intel Corporation

(21) Appl. No.: 11/170,277

(22) Filed: Jun. 29, 2005

(51) Int. Cl. G09G 3/36

(52) U.S. Cl. 345/88

(57) ABSTRACT

A method and system to show information on a display while reducing power consumption of the display includes using a color cylinder to filter light from a light source. The color cylinder is to rotate around the light source to enable different primary color light to be delivered to a display system in a time-domain sequence. Frames are shown on the display in multiple sub-frames. Each sub-frame is associated with a primary color and is shown in synchronization with the same primary color being displayed.

### FIELD OF INVENTION

The present invention relates generally to the field of power management; and, more specifically, to techniques for reducing power consumption of displays.

### BACKGROUND

Computer systems are becoming increasingly pervasive in our society, including everything from small handheld electronic devices, such as personal data assistants and cellular phones, to application-specific electronic devices, such as set-top boxes, digital cameras, and other consumer electronics, to medium-sized mobile systems such as notebook, sub-notebook, and tablet computers, to desktop systems, workstations, and servers. Computer systems typically include one or more processors. A processor may manipulate and control the flow of data in a computer. To provide more powerful computer systems for consumers, processor designers strive to continually increase the operating speed of the processor. As processor speed increases, the power consumed by the processor tends to increase as well. When the power is based on batteries, high power consumption may reduce the battery life.

One approach to reducing overall power consumption of a computer system is to change the focus of power reduction from the processor to other devices that have a significant impact on power. These other devices may include, for example, a display, an input/output (I/O) device, a memory, etc. Studies have shown that the display may consume as much as 30% to 40% of the total platform average power. In order to achieve a continuing goal of extending the battery life, techniques are being developed to reduce the power consumption of the display.

### BRIEF DESCRIPTION OF THE DRAWINGS

The present invention is illustrated by way of example and not limitation in the accompanying figures in which like references indicate similar elements and in which:

FIG. 1A is a block diagram illustrating an example of a prior art liquid crystal display (LCD) monitor.

FIG. 1B is a block diagram illustrating an example of a prior art liquid crystal matrix.

FIG. 1C is a block diagram illustrating an example of prior art pixel and sub-pixels.

FIG. 2A is a block diagram illustrating an example of a color cylinder, in accordance with one embodiment.

FIG. 2B is a block diagram illustrating an example of alternative embodiment of a color cylinder, in accordance with one embodiment.

FIG. 3 is a block diagram illustrating an example of an improved pixel, in accordance with one embodiment.

FIG. 4 is a block diagram illustrating an example of a logic that synchronizes the rotation of the color cylinder and the delivering of the data to be displayed, in accordance with one embodiment.

FIG. 5 is a block diagram illustrating an example of a process that may be used to control the displaying of the sub-frames, in accordance with one embodiment.

### DETAILED DESCRIPTION

In some embodiments, a display system may include a color cylinder and a light source. The color cylinder may include at least three color segments. As the color cylinder rotates, light from the light source is filtered by one of the three color segments. The filtered light is used to control color of information to be displayed on a liquid crystal display (LCD).

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

Display System

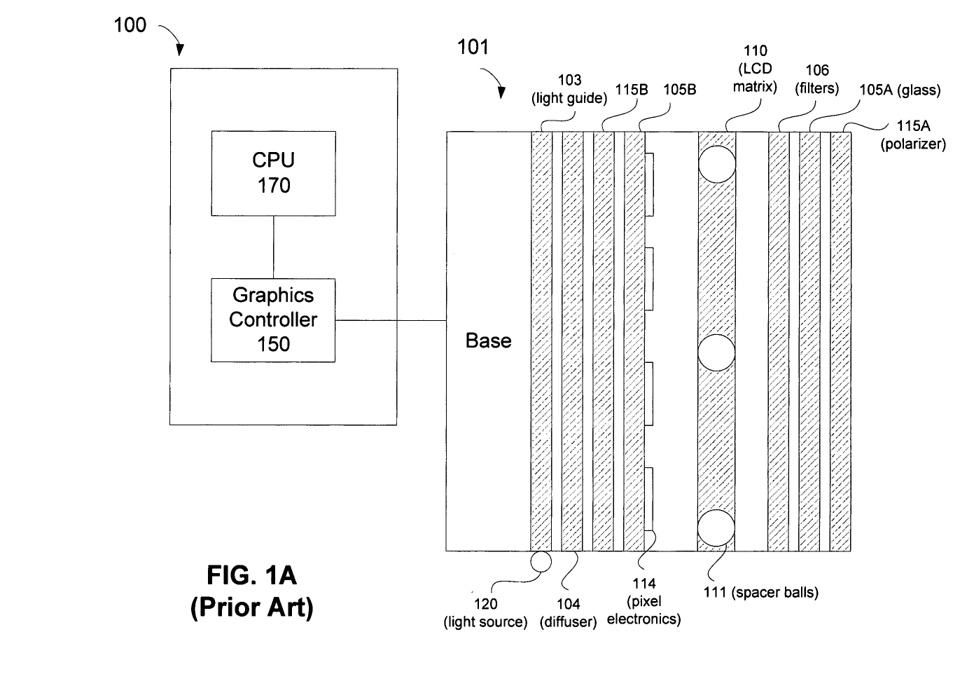

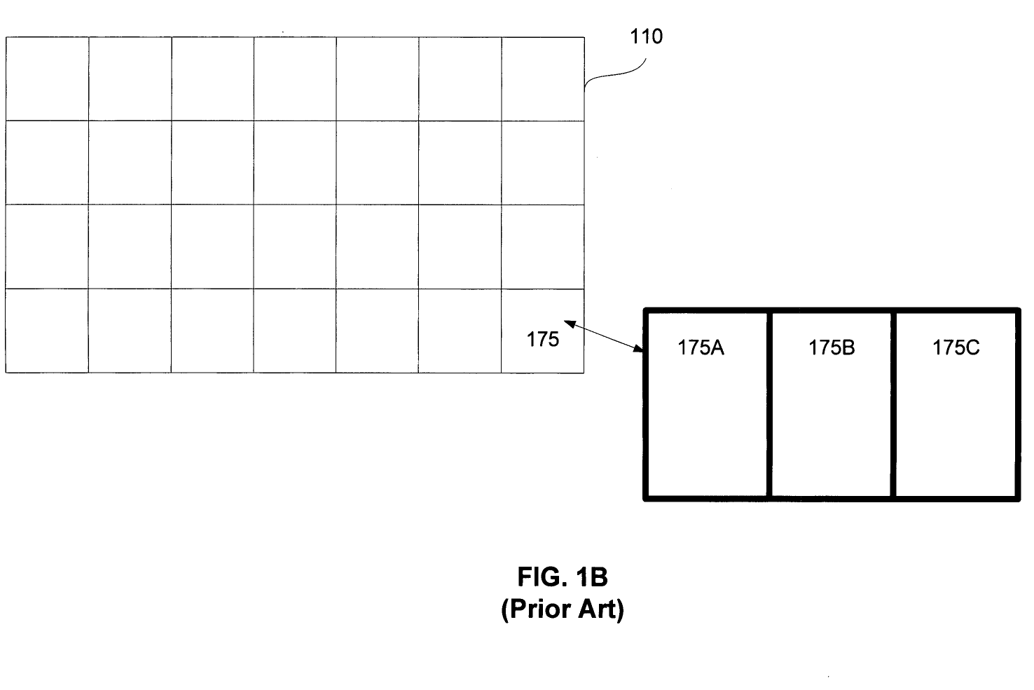

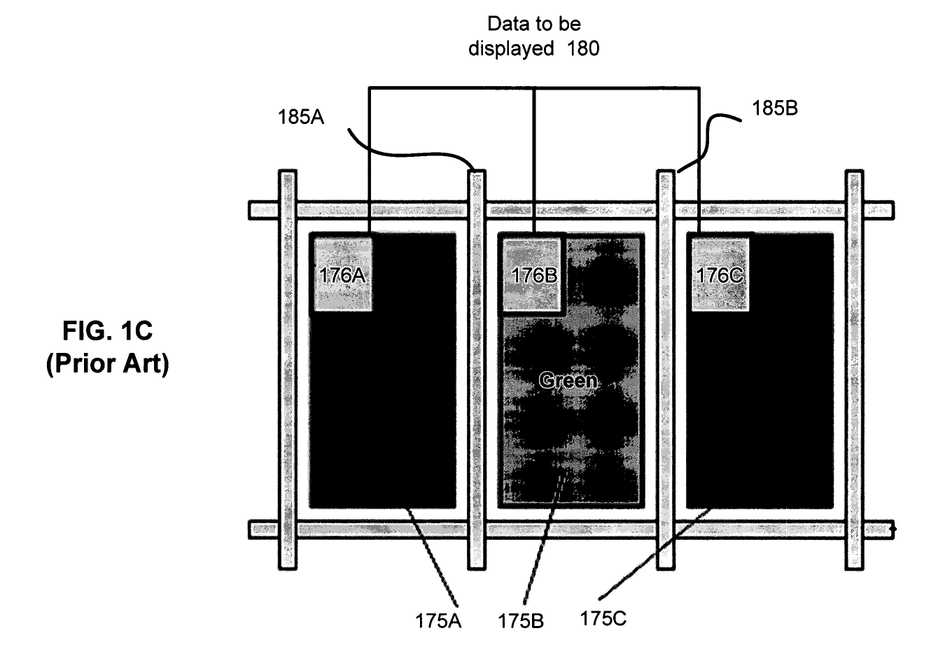

FIG. 1A is a block diagram illustrating an example of a prior art display system. The display system may be a liquid crystal display (LCD) monitor. Typically, from the front, LCD monitor 101 may include a first polarizer 115A, a first glass substrate 105A, color filters 106, a liquid crystal (LC) matrix 110 and spacer balls 111, a second glass substrate 105B, a second polarizer 115B, a light guide 103, and a light diffuser 104. The color filters 106 may be etched onto the first glass substrate 105A. The second glass substrate 105B may include pixels electronics 114. The pixel electronics 114 may include transistors and storage capacitors (not shown) and are used to control light passing through the LC matrix 110. On each side of the LC matrix 110 may be an alignment film (not shown).

A light source 120 (also referred to as a back light) is positioned near the light guide 103. Light from the light source 120 is transmitted by the light guide 103 and the light diffuser 104 to the light polarizer 115B. The light polarizer 115B may then distribute the light uniformly to the LC matrix 110. Display data may be delivered to the LCD monitor 101 by a graphics controller 150 associated with a processor 160 within computer system 100. Although not shown, the computer system 100 may also include other components (e.g., memory, bus, etc.) that may be used to control information to be displayed on the LCD monitor 101.

The LC matrix 110 (also referred to as a thin film transistor (TFT) matrix) may include multiple cells, as illustrated in an example in FIG. 1B. Each cell may represent a pixel (picture element) such as, for example, pixel 175. Each pixel from the LC matrix 110 may be associated with pixel electronics. Typically, each pixel is comprised of three sub-pixels. For example, the pixel 175 may include sub-pixels 175A, 175B and 175C. The higher the resolution of the LCD monitor 101, the higher the number of pixels (and accordingly the number of sub-pixels) and the higher the number of pixel electronics. For example, for an LCD display with XGA (extended graphics array) resolution, the number of pixels may be 1024×768×3 with the last multiplier reflecting the number of sub-pixels.

Each sub-pixel may be associated with a primary color (e.g., red, green, or blue). The pixel electronics 114 may include a transistor that acts as a switch to control the light passing through each of the sub-pixels. The light that passes through may then go through the color filter 106 which may filter all colors except for the primary color that the sub-pixel is associated with. The color filter (also referred to as micro-filters) 106 may be integrated into the first glass substrate 105A. For example, the sub-pixels 175A, 175B and 175C may be associated with a red, green, and blue filter, respectively. This is illustrated in an example in FIG. 1C. The amount of light that the pixel electronics 176A allow passing through the sub-pixel 175A (associated with the red filter) depend on the properties of the data to be displayed at the pixel 175. For example, when the data 180 is to be displayed (at the pixel 175) in a specific color, the pixel electronics 176A, 176B and 176C may allow different levels of light to pass through to the three sub-pixels 175A, 175B and 175C, respectively. In this example, the combination of the different light level passing through the sub-pixels 175A, 175B and 175C (and filtered by the red, green and blue filters, respectively) may be viewed by a user as the desired color.

It may be noted that the data 180 may be delivered to the pixel 175 at every frame interval (also referred to as a frame refresh rate), and the color of the data is displayed to the user via the red, green and blue filters at the same time during the frame interval. For example, when the frame refresh rate is 60 Hz, the colors red, green, and blue may also be transmitted via the sub-pixels 175A, 175B and 175C simultaneously at 60 Hz and until the next frame refresh.

As illustrated in FIG. 1C, the sub-pixels 175A, 175B and 175C may be separated from one another by vertical grid lines 185A and 185B. There may also be horizontal and vertical grid lines separating adjacent pixels. These grid lines may be wires associated one or more sub-pixels within the liquid crystal matrix 110. For example, the wires may be used to carry signals to the pixel electronics 176A, 176B and 176C. When there are more pixels (e.g., higher resolution), there are more wires. The number of wires may occupy a large percentage of the LC matrix 110 and may substantially block the light that is delivered by the light polarizer 115B. In addition to the wires, the pixel electronics 176A, 176B and 176C may also block the light that is delivered by the light polarizer 115B.

Let aperture ratio be defined as a percentage of an LCD display that may not be blocked by any pixel electronics and grid lines, the following formula may provide an approximation of such a ratio:

$$Aperture Ratio = \frac{{A}_{Pixel}}{{A}_{Pixel} + {A}_{TFT} + {A}_{Line}} \approx 60 \% ,$$

where Aₚᵢₓₑₗ is the transmissive area of the pixel, A_{TFT} is the area occupied by the TFT (or pixel electronics) in each pixel, and A_{Line} is the area occupied by the row and column grid lines for each pixel. For a high definition LCD display having a resolution of 1920×1080 pixels, the aperture ratio may be approximately 60%. To compensate for the low aperture ratio, the intensity of the light source 120 may need to be increased to increase the brightness resulting in higher power consumption.
Color Cylinder

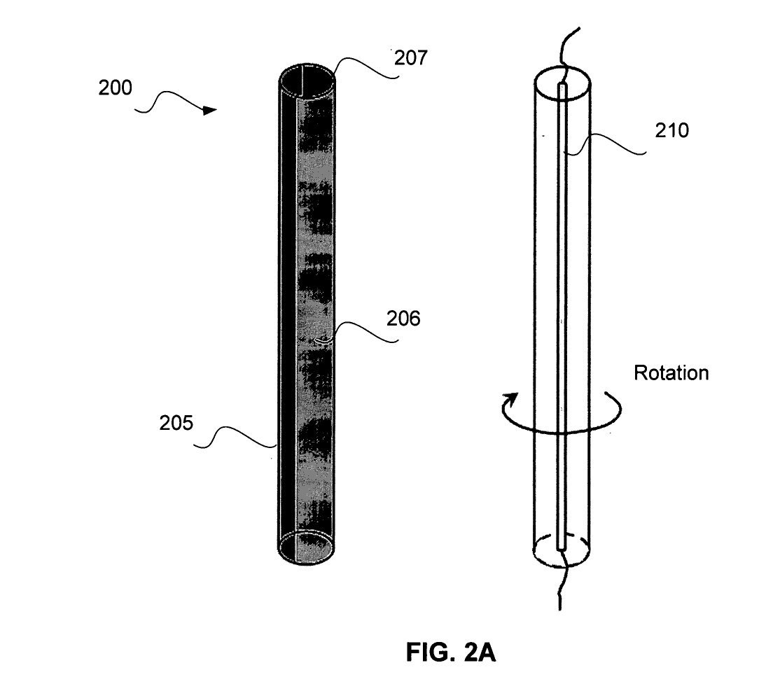

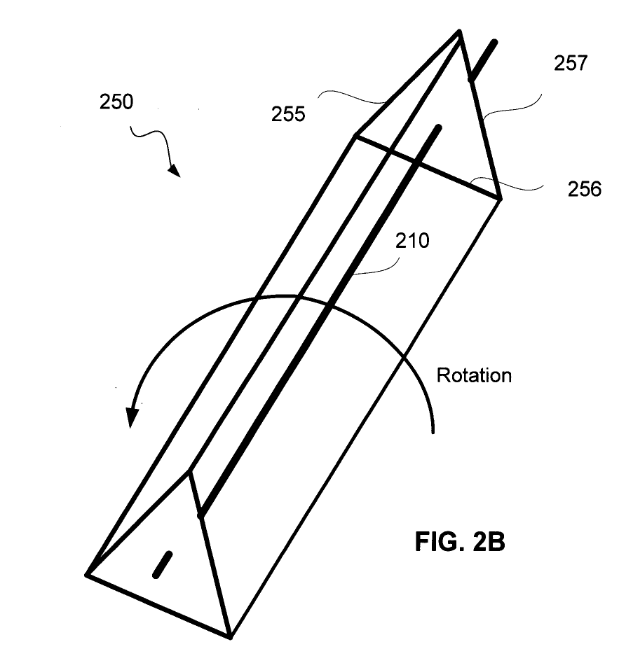

FIG. 2A illustrates one example of a color cylinder, in accordance with one embodiment. Color cylinder 200 may include a cavity and may be coupled to a light source assembly (or light source) 210. The color cylinder 200 may be coupled to the light guide 104 and the light diffuser 104 (as illustrated in FIG. 1A). The light source 210 may be positioned at substantially along the center axis and the length of the color cylinder 200. For one embodiment, the color cylinder 200 may be cylindrical in shape and its circumference may include color segments. There may be at least three color segments, each associated with a primary color. For example, the color segments 205, 206 and 207 are associated with the color red, green and blue (or red, blue, and green) respectively. Alternatively, the number of color segments may be in multiples of three in similar pattern. For example, the number of color segments may be six (6) or nine (9) following the pattern red, green, and blue.

For one embodiment, the color segments 205, 206 and 207 may each occupy approximately one third of the circumference of the color cylinder 200, as shown in FIG. 2A. Alternatively, the size of each of the color segments may be different from one another. For example, the color cylinder 200 may have a larger red color segment and blue segment. The color segments may serve as global color filters of the light transmitted by the light source 210. It may be noted that this is different from having the multiple color micro-filters being associated with the glass substrate 105A as described above. Having the color filters implemented in the color cylinder 200 may eliminate the need for the micro-filters integrated on the glass substrate 105A and reduce the manufacturing complexity and the associated costs.

For one embodiment, the light source 210 may be based on CCFL (Cold cathode fluorescent lighting) technology. It may be noted that there may be multiple CCFL light sources. In this situation, there may be one color cylinder for each CCFL light source, and the operation of the cylinders may need to be coordinated so that the same color is distributed by the light polarizer 115B (as illustrated in FIG. 1A).

For another embodiment, the light source 210 may be based on LED (light emitting diode) technology. It may be noted when the light source 210 includes one or more LEDs, the LEDs may all emit the same color. For one embodiment, the color of the light from the light source 210 may be white. One advantage of using white light LEDs or CCFL light is that they are relatively inexpensive comparing to other types of light sources. FIG. 2B illustrates color cylinder 250 as one alternative embodiment having triangular shape and three color segments 255, 256 and 257. Other embodiments may be possible as long as they have color segments and a cavity to house a light source such as the light source 210.

For one embodiment, the color cylinder 200 may rotate along its axis, as illustrated in FIGS. 2A and 2B. The rotation may be clockwise or counter clockwise. The rotation may allow a different primary color to be transmitted by the combination of the light source 210 and the color cylinder 200 to the light polarizer 115B. The light polarizer 115B may help distribute the primary color light evenly to a LC matrix 110. The color cylinder 200 may rotate at a certain rotation speed to enable the same primary color light to be transmitted to the light polarizer 115B for a certain length of time (referred to herein as color segment interval). It may be noted that at any one time, only one primary color is transmitted to the light polarizer 115B. The other two primary colors may be absorbed. The process may be repeated after every third primary color in a sequential pattern (e.g., red, green, blue, red, green, blue, etc.).

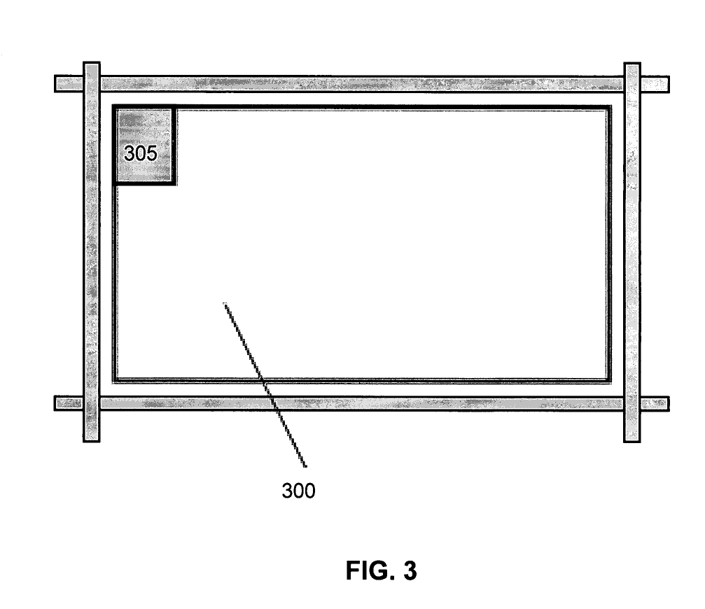

FIG. 3 is a block diagram illustrating an example of an improved pixel, in accordance with one embodiment. Pixel 300 is different from the pixel described in the example in FIG. 1C because pixel 300 may not include three sub-pixels and wires separating the sub-pixels. Furthermore, because there are no sub-pixels, the overall number of pixels is reduced by approximately three times. The pixel 300 may need only one pixel electronics 305 (instead of three) to control the light passing through the pixel 300. When the light polarizer 115B distributes a primary color light from the combination of the light source 210 and the color cylinder 200, the pixel electronics 305 may cause the primary color light to be blocked or pass through. Thus, at any one time, the user may see the display as all red, all green, or all blue.

The reduction in the number of pixels by there times, and the reduction in the number of grid lines (e.g., wires) may significantly reduce the blockage of light from the light polarizer and enhance the brightness of the display. The formula to approximate the aperture ratio described above may be adjusted as:

$$Aperture Ratio = \frac{{A}_{Pixel}}{{A}_{Pixel} + \frac{1}{3} ( {A}_{TFT} + {A}_{Line} )} \approx 82 \%$$

Note that the total number of pixel electronics and grid lines are divided by three. With the LCD display having 1920×1080 pixels, the aperture ratio may be >80%. Thus for a similar display brightness, the power consumption associated with the light may be reduced by more than 20% in this example.
Speed of Rotation of the Color Cylinder

It is recognized that by increasing the speed of displaying each of the three primary colors one after another and by varying the amount of light that is allowed to pass through a pixel, a user may perceive the pixel as being shown in different colors. For one embodiment, the time for the color cylinder 200 to complete one rotation may be the same as the frame interval, as described above. Thus, because the color cylinder 200 may include three color segments, a color segment interval may be approximately the same as one third of the frame interval when the color segments have approximately the same size. As the color cylinder 200 rotates, a different primary color may be transmitted to the light polarizer 115B at every color segment interval. It may be noted that the rotation of the color cylinder 200 may consume a certain amount of power. However, this may be small compared to the power savings associated with the light source 210 using the techniques described.

Sub-Frames

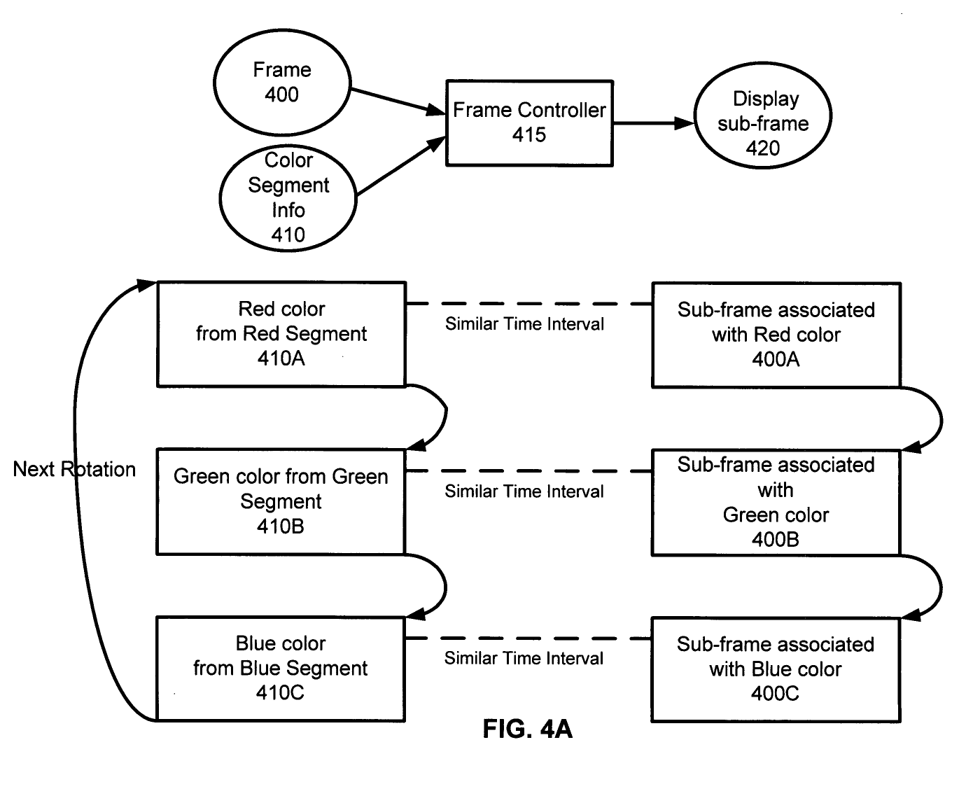

FIG. 4 is a block diagram illustrating an example of a frame controller and sub-frames, in accordance with one embodiment. For one embodiment, a data frame may be divided into at least three sub-frames. For example, frame 400 may be divided into three sub-frames 400A, 400B and 400C. Alternatively, there may be multiples of three sub-frames. For one embodiment, each of the sub-frames may be associated with a primary color. For example, the sub-frame 400A may include data to be displayed in the color red; the sub-frame 400B may include data to be displayed in the color green; the sub-frame 400C may include data to be displayed in the color blue. The frame division may be performed by logic referred to herein as frame controller 415. The frame controller 415 may be associated with an improved LCD monitor having the pixels as described with FIG. 3 and a color cylinder as described with FIGS. 2A and 2B. Alternatively, the frame controller 415 may be associated with the graphics controller 150. The frame controller 415 may be implemented in software, hardware or a combination of both software and hardware.

Synchronization

The frame controller 415 may receive rotation information associated with a color cylinder (e.g., color cylinder 200). The rotation information may include color segment information 410. The frame controller 415 may use the rotation information and the color segment information 410 to synchronize with a sub-frame to be displayed. For example, when the color segment information 410 indicates that the current color segment is red (block 410A), the frame controller 415 may deliver the sub-frame 400A, etc. It may be noted that the data associated with the sub-frame 400A can include those that may be displayed in a color that needs the color red as a primary color. Depending on how much of the color red is needed at the pixel level, the pixel electronics 305 (illustrated in FIG. 3) may control the level of the red light to pass through. As mentioned above, in this example a user may see the display as all red.

For one embodiment, the data associated with each sub-frame may be displayed for a time interval that is approximately equal to the color segment interval. For example, when the frame controller 415 synchronizes the color segment information 410 with the sub-frame to be displayed, the time that the primary color is distributed by the light polarizer 115B may be similar to the time the sub-frame associated with the same primary color is shown on the improved LCD display. As illustrated in FIG. 4, the time that the red color is distributed by the light polarizer 115B (block 410A) may be similar to the time that the sub-frame associated with the red color is displayed (block 400A). It may be noted that as the rotation of the color cylinder (e.g., cylinder 200) transitions from the red segment (block 410A) to the green segment (block 410B), the frame controller 415 may transition from the sub-frame 400A to the sub-frame 400B. It may also be noted that when there are multiples of three color segments or when the sizes of the color segments are not similar, the frame controller 415 may need to be synchronize the sub-frames accordingly.

To support the displaying of the three sub-frames within a frame interval, the LC material employed in the LCD matrix 110 may need to be faster than they are in the traditional LC matrix. For example, in the traditional LCD monitors, an LC response time of 20-25 ms may be considered adequate. To support the techniques described herein, the LC response time may need to be at least three-times as fast (e.g. ˜8 ms).

Process

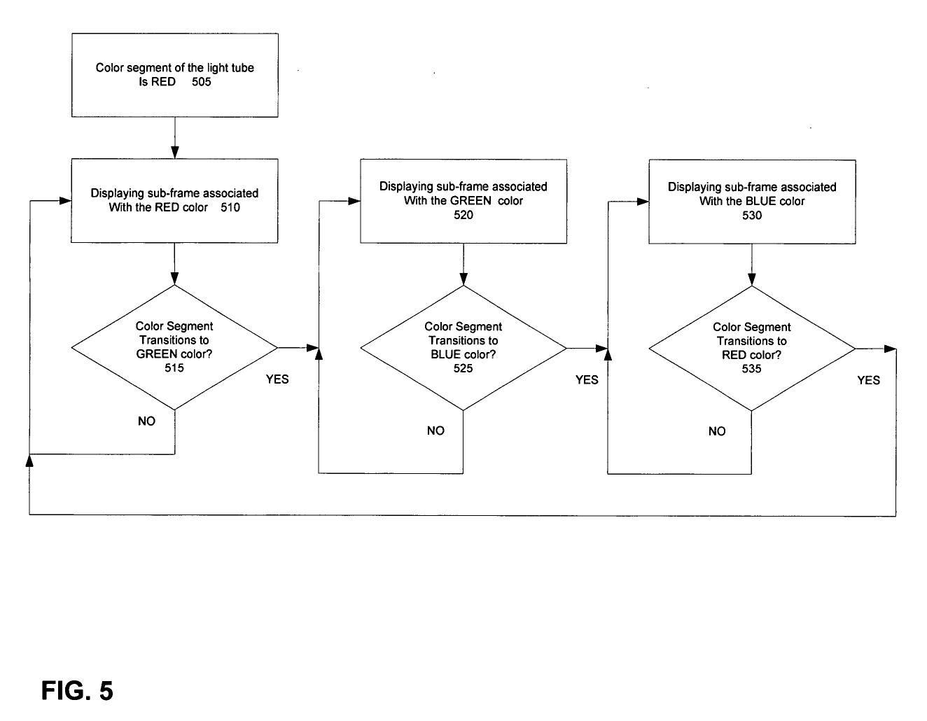

FIG. 5 is a block diagram illustrating an example of a process that may be used to control the displaying of the sub-frames, in accordance with one embodiment. The process assumes that the color cylinder is rotating and that the sequence of the color segments is red segment, green segment and blue segment. Other sequence may also be used. In this example, as shown in block 505, the red color segment of the color cylinder is currently used as a color filter. This information is received by the frame controller 415 and used to cause the sub-frame associated with the red color to be displayed, as shown in block 510. At block 515, a test is performed to determine if the color cylinder rotates from the red color segment to the green color segment. If the transition to the green color segment has not taken place, the process flows to block 510 where the frame controller 415 continues to display the sub-frame associated with the red color.

If the transition from the red segment to the green segment takes place, the process flows to block 520 where the frame controller 415 displays the sub-frame associated with the green color instead of the sub-frame associated with the red color. At block 525, a test is performed to determine if the color cylinder rotates from the green color segment to the blue color segment. If the transition to the blue color segment has not taken place, the process flows to block 520 where the frame controller 415 continues to display the sub-frame associated with the green color. If the transition from the green segment to the blue segment takes place, the process flows to block 530 where the frame controller 415 displays the sub-frame associated with the blue color instead of the sub-frame associated with the green color.

At block 535, a test is performed to determine if the color cylinder rotates from the blue color segment to the red color segment. This situation occurs when the color cylinder completes one rotation. If the transition to the red color segment has not taken place, the process flows to block 530 where the frame controller 415 continues to display the sub-frame associated with the green color. If the transition from the blue segment to the red segment takes place, the process flows to block 510 where the frame controller 415 displays the sub-frame associated with the red color instead of the sub-frame associated with the blue color. It may be noted that the total length of time that the three sub-frames are displayed may be approximately the same as the frame interval. Thus, it may be possible that when the process returns to block 510, the frame controller 415 may display a different sub-frame associated with the red color.

Computer Readable Media

The operations of these various methods may be implemented by a processor in a computer system, which executes sequences of computer program instructions that are stored in a memory which may be considered to be a machine-readable storage media. The memory may be random access memory, read only memory, a persistent storage memory, such as mass storage device or any combination of these devices. Execution of the sequences of instruction may cause the processor to perform operations according to the process described in FIG. 5, for example.

The instructions may be loaded into memory of the computer system from a storage device or from one or more other computer systems (e.g. a server computer system) over a network connection. The instructions may be stored concurrently in several storage devices (e.g. DRAM and a hard disk, such as virtual memory). Consequently, the execution of these instructions may be performed directly by the processor. In other cases, the instructions may not be performed directly or they may not be directly executable by the processor. Under these circumstances, the executions may be executed by causing the processor to execute an interpreter that interprets the instructions, or by causing the processor to execute a compiler which converts the received instructions to instructions that which can be directly executed by the processor. In other embodiments, hard-wired circuitry may be used in place of or in combination with software instructions to implement the present invention. Thus, the present invention is not limited to any specific combination of hardware circuitry and software, nor to any particular source for the instructions executed by the computer system.

Although some embodiments of the present invention have been described with reference to specific exemplary embodiments, it will be evident that various modifications and changes may be made to these embodiments without departing from the broader spirit and scope of the invention as set forth in the claims. For example, although some embodiments have been described as being associated with a computer system, the color cylinder may also be used in various other applications (e.g., television systems, etc.). Accordingly, the specification and drawings are to be regarded in an illustrative rather than a restrictive sense.

What is claimed is:

1. A method, comprising:
using a color cylinder to filter colors to be shown on a display, wherein the color cylinder is coupled to a light source and includes multiple color segments.

2. The method of claim 1, wherein the color cylinder includes at least three color segments, each associated with a primary color.

3. The method of claim 2, wherein the three color segments include a red segment, a green segment and a blue segment.

4. The method of claim 3, wherein the light source is a white light source positioned inside the color cylinder, and wherein the display is a liquid crystal display (LCD).

5. The method of claim 4, wherein the light source is positioned along an axis of the color cylinder, and wherein the color cylinder is to rotate around the axis such that light from the light source is filtered by the red segment, the blue segment or the green segment.

6. The method of claim 5, wherein the color cylinder is coupled to a light guide and a light diffuser to transmit to the LCD the light filtered by the red segment, the blue segment or the green segment.

7. The method of claim 6, further comprising:
causing data to be shown on the LCD in multiple sub-frames, wherein each sub-frame is associated with a primary color, and wherein the multiple sub-frames are associated with a frame.

8. The method of claim 7, wherein the multiple sub-frames are shown on the LCD in a similar time interval as when the frame is shown on the LCD.

9. The method of claim 8, wherein a first sub-frame is shown based on its association with a first primary color and during a similar time interval as when the light guide and the light diffuser transmit the light filtered by a color segment having the first primary color.

10. The method of claim 9, wherein the light source is a cold cathode fluorescent lighting (CCFL) light source or a light emitting diode (LED) light source.

11. An apparatus, comprising:
a light source;
a light guide and a light diffuser coupled to the light source to transmit light; and
a cylinder having a cavity to house the light source, wherein the cylinder is to include color segments in primary colors, each color segment filtering light from the light source such that the light guide and the light diffuser transmit a primary color light.

12. The apparatus of claim 11, wherein the light source is to be positioned along an axis of the cylinder, and wherein the cylinder is to rotate around the axis.

13. The apparatus of claim 12, wherein the light guide and the light diffuser are to transmit the primary color light to a liquid crystal display (LCD).

14. The apparatus of claim 13, wherein data is shown on the LCD in multiple sub-frames within a frame time.

15. The apparatus of claim 14, wherein each of the multiple sub-frames is to be associated with a primary color.

16. The apparatus of claim 15, wherein a sub-frame associated with a first primary color is shown when the light guide and the light diffuser transmit light having the first primary color, and wherein a sub-frame associated with a second primary color is shown when the light guide and the light diffuser transmit light having the second primary color.

17. The apparatus of claim 16, wherein a time for the cylinder to complete one rotation around the axis is approximately equal to the frame time.

18. An apparatus, comprising:
a light source positioned inside a cylinder and along an axis of the cylinder, the cylinder including at least three color segments each having a primary color, the cylinder is to rotate around its axis to enable the color segments to filter light from the light source; and
a light guide and a light diffuser coupled to the cylinder to distribute light filtered by the color segments;

19. The apparatus of claim 18, further comprising:
a liquid crystal (LC) matrix positioned between a first glass substrate and a second glass substrate; and
a controller to synchronize the light filtered by the color segments with information to be delivered to the LC matrix.

20. The apparatus of claim 19, wherein the information is to be delivered in multiple sub-frames, each sub-frame corresponding to a color of the light filtered by a color segment.

21. The apparatus of claim 20, wherein the number of color segments is in multiples of three in repeating pattern of the primary colors.

22. The apparatus of claim 20, wherein at least two color segments have different sizes.
